(19) United States
(12) Patent Application Publication
(10) Pub. No.: US 2006/0011740 A1
(43) Pub. Date: Jan. 19, 2006

(54) Scraper device for aerator installed on a faucet

(75) Inventor: Orlando Bosio, Casaloldo (IT)

Correspondence Address: MODIANO & ASSOCIATI, Via Meravigli, 16, MILAN, 20123, IT

(73) Assignee: AMFAG S.p.A.

(21) Appl. No.: 11/177,377

(22) Filed: Jul. 11, 2005

(30) Foreign Application Priority Data
Jul. 13, 2004 (IT) MN2004A000016

(51) Int. Cl. B05B 1/28; B05B 15/02; F23D 11/34; F23D 11/38

(52) U.S. Cl. 239/104; 239/114; 239/123

(57) ABSTRACT

A scraper device for an aerator installed on a faucet, comprising an enclosure with a wall provided with openings for the passage of air and a bottom provided with a screen shaped like a grid, which is designed to be crossed by the stream of water in output from the faucet, and having an end portion which is associated with grip means and is provided with removal means adapted to remove by manual actuation limescale deposited on the aerator.

The present invention relates to a scraper device for an aerator installed on a faucet.

### BACKGROUND OF THE INVENTION

It is known that there are devices, known as aerators, which are designed to be inserted at the end section of pipes that convey water in output from faucets installed in a sanitary fixtures or on kitchen sinks in order to produce a properly aerated cylindrical jet without sprays.

Such aerators comprise an outer enclosure, the wall whereof is provided with openings designed to allow the passage of air which, by penetrating from outside into the portion of space that is present in the peripheral region of said enclosure, enters the stream of water conveyed by the faucet in order to mix with said stream.

At the bottom, the outer enclosure is provided with a screen, which is designed to be crossed by the water in output from the faucet and is provided in the form of a grid with variously shaped meshes.

The limescale contained in the water that passes through the grid tends to deposit on the ribs that form said grid and along the paths where the air passes, causing clogging which unacceptably affects the outflow characteristics of the stream, and therefore the aim of the present invention is to provide a scraper device that the user can have available in order to restore periodically, with the greatest simplicity, optimum operating conditions by acting on the aerator in order to remove the deposited limescale.

### SUMMARY OF THE INVENTION

The proposed aim is achieved by a scraper device for an aerator installed on a faucet, according to the invention, said aerator comprising an enclosure with a wall provided with openings for the passage of air and a bottom provided with a screen shaped like a grid, which is designed to be crossed by the stream of water in output from the faucet, characterized in that it comprises an end portion which is associated with grip means and is provided with means adapted to remove by manual actuation limescale deposited on the aerator.

### BRIEF DESCRIPTION OF THE DRAWINGS

Further characteristics and advantages will become better apparent from the description of some preferred but not exclusive embodiments of the device according to the invention, illustrated by way of non-limiting example in the accompanying drawings, wherein:

FIG. 1 is a perspective view of the device according to the invention;

FIG. 2 is a view of the device according to the invention ready for use on an aerator;

FIG. 3 is the view of the end portion of the device according to the invention in a different embodiment;

FIGS. 4, 6, 8, 10 are views of further embodiments of the end portion of the device according to the invention;

FIGS. 5, 7, 9, 11 are sectional views, taken respectively along the lines V-V of FIG. 4, VII-VII of FIG. 6, IX-IX of FIG. 8, XI-XI of FIG. 10;

FIG. 12 is a view of another embodiment of the device according to the invention, ready for use on an aerator which is different from the one shown in FIG. 2.

### DESCRIPTION OF THE PREFERRED EMBODIMENTS

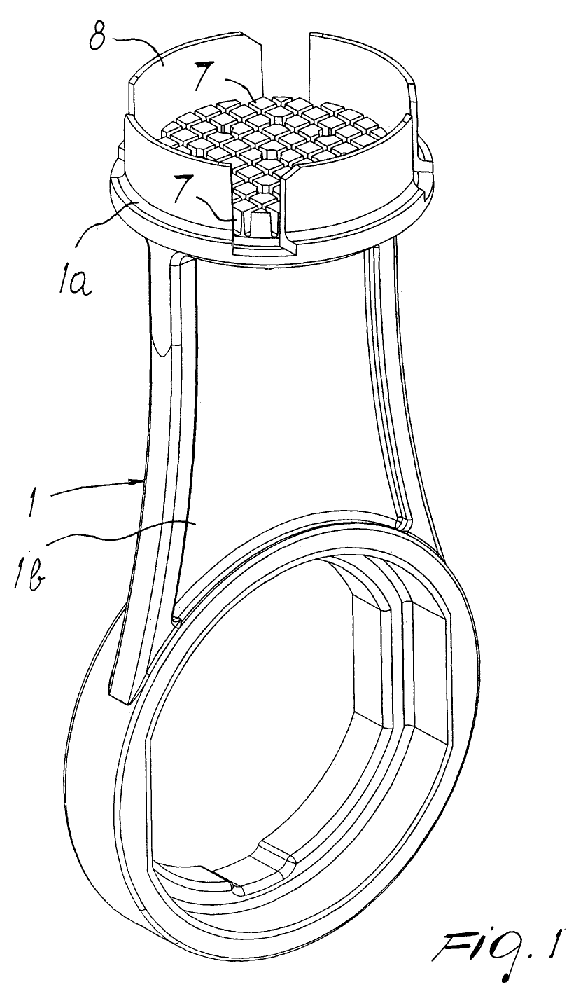

With reference to FIGS. 1 and 2, the reference numeral 1 generally designates the scraper device according to the invention, which comprises the end portion 1a located at the end of the grip handle 1b, and the reference numeral 2 designates an aerator, which is associated with the ring 3 screwed onto the pipe 4 that conveys water in output from a faucet, at the end section of said pipe.

The aerator 2 comprises the outer enclosure 5, the wall whereof is provided with openings, in a known manner, which are designed to allow the passage of air which, by penetrating from outside into the portion of space 6 provided in the peripheral region of said enclosure, enters the stream of water conveyed by the pipe 4 in order to mix with said stream.

At the bottom, the enclosure 5 of the aerator is provided with the grid 5a, which is designed to be crossed by the stream of water; in the illustrated example, said grid has square meshes but could also be provided with meshes of any shape.

Limescale deposition occurs, during use of the faucet, at least at said grid 5a, and by gradually increasing causes a gradual blockage of the meshes of the grid and therefore has to be removed periodically.

For this purpose, the end portion 1a of the scraper device or scraper is provided with limescale removal means such as a plurality of cutting edges such as plugs 7, which are adapted to enter the meshes of the grid 5a by skimming the edges of said meshes; more specifically, it is noted that said plugs are delimited by flat faces which converge at sharp edges.

Aerators with different grids will be provided, of course, with scraper devices having different complementary plugs, as is the case for example of FIG. 12, in which intervention on the aerator 2a, in which the bottom grid is structured with meshes that are different from the ones of the aerator 2 of FIG. 2, is provided with the scraper 2b, which has plugs such as 2c which are complementary with respect to said meshes.

The end portion 1a is completed by the four wings such as 8, which are adapted to enter the portion of space 6 provided in the peripheral region of the enclosure 5 of the aerator 2, and it should be noted that the number and breadth of said wings may be any; there may also be a single wing that affects the entire circumference of the end portion and is provided with teeth on its edge.

When it is necessary to free the aerator 2 from limescale deposited thereon, the user acts with the scraper 1, applying a rotary motion guided by the insertion of the wings such as 8 in the portion of space 6, and this motion is already in itself effective in determining the separation of any limescale that is present at said portion of space.

The rotary motion of the scraper 1 in contact with the limescale is accompanied by an axial motion, thus removing the portion that protrudes from the ribs of the grid 5a; once action on said portion of limescale has been completed, it becomes possible, when the plugs such as 7 face the meshes of the grid 5a as a consequence of the rotary motion of the scraper 1, to insert said plugs in said meshes, consequently separating the limescale that is present thereat and completely freeing the aerator from any trace of clogging caused by the stream of water following to the opening of the faucet.

If it is possible to exclude any possibility of blockage of the portion of space 6, it is possible to adopt a scraper with an end portion 9 of the type that can be seen in FIG. 3, provided again with the plugs such as 7 but without the wings such as 8.

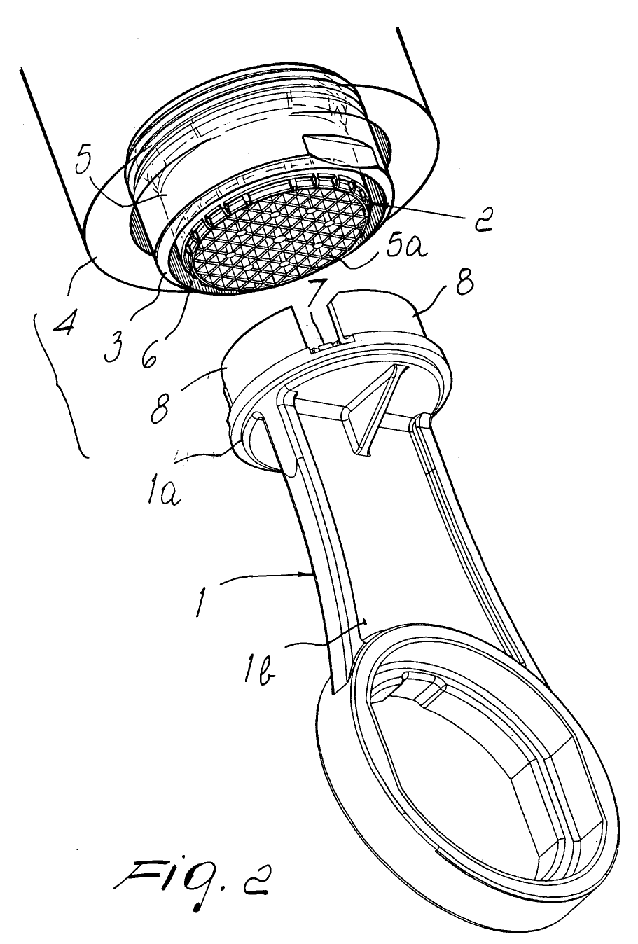

Another embodiment of the device according to the invention is the one shown in FIGS. 4 and 5: according to this embodiment, the end portion 10 of the scraper is provided with sawtooth-like blades such as 11 and there can be at least one wing such as 8.

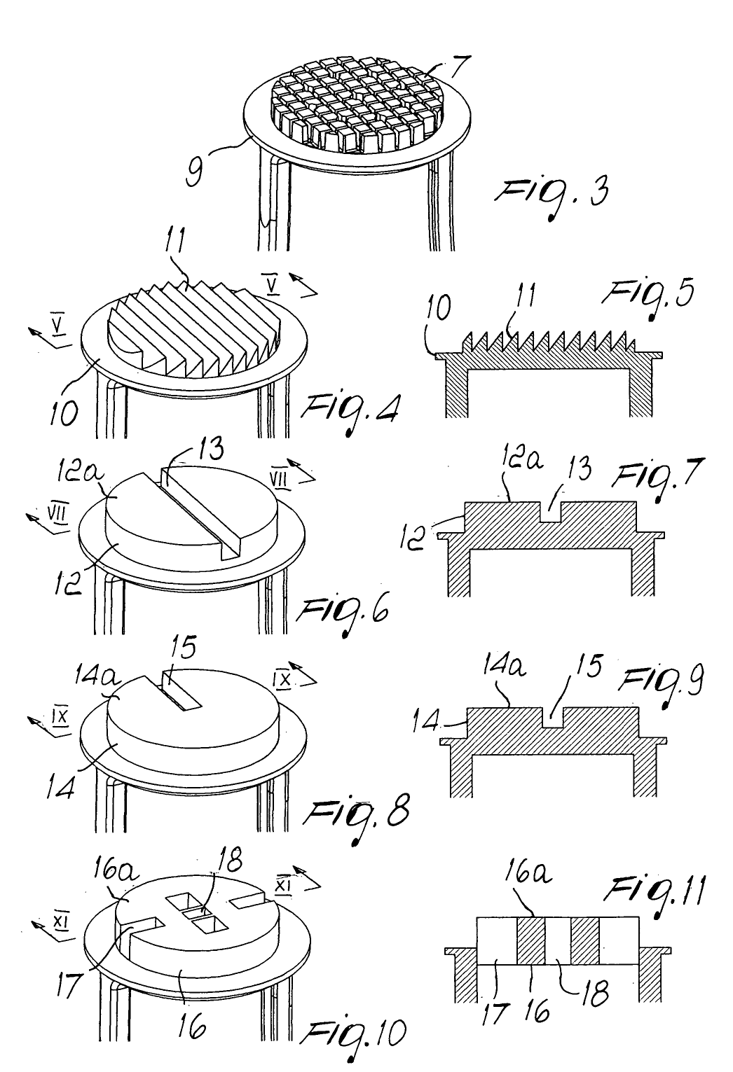

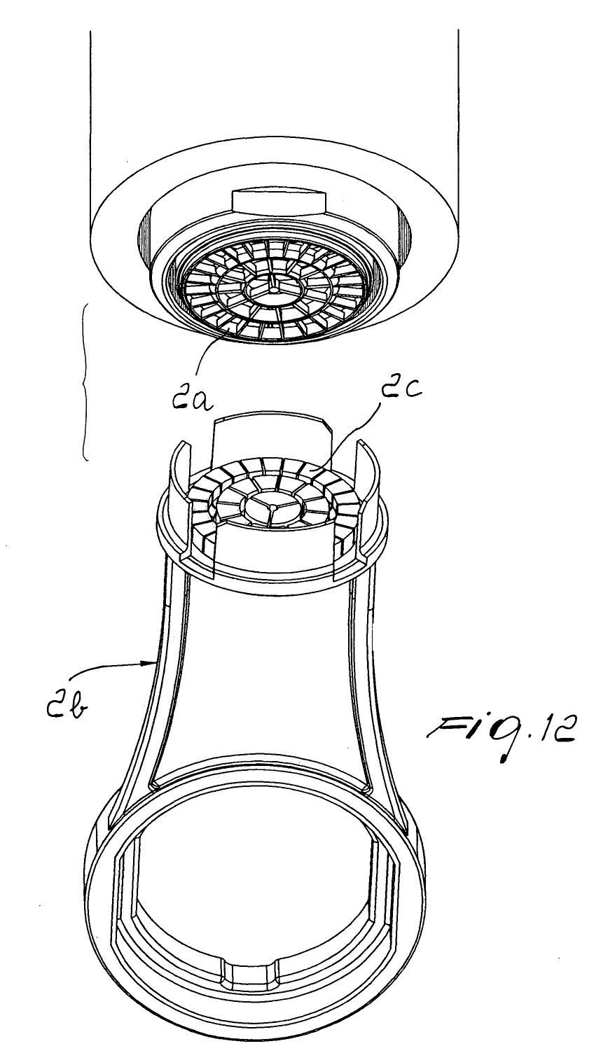

FIGS. 6 to 11 illustrate additional embodiments, in which the end portion of the scraper comprises a flat face which is provided with at least one recess with sharp edges: in this way, the end portion of FIGS. 6 and 7 comprises the cylindrical block 12, in which the flat base 12a is provided with the recess 13, which runs along a diameter over its entire length, and the end portion of FIGS. 8 and 9 likewise comprises the block 14, which is provided on the flat base 14a with a recess 15, which runs along half of its diameter; finally, the end portion of FIGS. 10 and 11 comprises the block 16, which has, at the flat base 16a, a plurality of recesses such as 17 and 18, which are distributed along two perpendicular diameters, and said recesses, differently from the recesses 13 and 15 described earlier, are through recesses.

All the end portions shown in FIGS. 6 to 11 may be provided with at least one wing such as 8.

Finally, it is noted that all the shapes of the blades comprised in the invention may have a sharp edge or a rounded edge.

The described invention is susceptible of numerous other modifications and variations, all of which are within the scope of the appended claims; all the details may further be replaced with other technically equivalent elements.

The disclosures in Italian Patent Application No. MN2004A000016 from which this application claims priority are incorporated herein by reference.

What is claimed is:

1. A scraper device for an aerator installed on a faucet, the aerator having an enclosure with a wall provided with openings that allow passage of air and a bottom provided with a screen shaped like a grid to be crossed by a stream of water in output from a faucet, the scraper device comprising: an end portion; grip means for hand gripping, that are associated with said end portion; and removal means provided at said end portion for removal by manual actuation of limescale deposited on the aerator.

2. The scraper of claim 1, wherein said removal means are blades adapted to remove limescale.

3. The scraper of claim 2, wherein said removal means are blades that have a sharp edge.

4. The scraper of claim 2, wherein said removal means are blades that have a rounded edge.

5. The scraper of claim 1, wherein said removal means are plugs which are adapted to enter meshes of a grid comprised in a bottom of an enclosure of an aerator, so as to graze edges of the meshes.

6. The scraper of claim 2, wherein said blades are shaped like plugs which are adapted to enter meshes of a grid comprised in a bottom of an enclosure of an aerator, so as to graze edges of the meshes.

7. The scraper of claim 1, wherein said removal means are sawtooth-shaped blades.

8. The scraper of claim 1, wherein said end portion comprises a flat face which has at least one through recess with sharp edges that are adapted to remove limescale.

9. The scraper of claim 1, wherein said end portion comprises a flat face provided with at least one non-through recess with sharp edges that is adapted to remove limescale.

10. The scraper of claim 1, wherein said end portion has a circular flat face provided with a recess which lies along a diameter over an entire length thereof that is adapted to remove limescale.

11. The scraper of claim 1, wherein said end portion comprises a flat circular face provided with a recess which lies along a diameter over a fraction of a length of said diameter and which is adapted to remove limescale.

12. The scraper of claim 1, wherein said end portion comprises a flat circular face provided with a plurality of recesses distributed along two perpendicular diameters thereof and adapted to remove limescale.

13. The scraper of claim 1, wherein said end portion is provided with at least one peripheral wing, which is adapted to enter a space at a peripheral region of an enclosure of an aerator.

14. The scraper of claim 5, wherein said end portion is provided with at least one blade-like peripheral wing which is adapted to enter a space at a peripheral region of an enclosure of an aerator.
